(19) United States
(12) Patent Application Publication
(10) Pub. No.: US 2008/0105654 A1
(43) Pub. Date: May 8, 2008

(54) Polyphase Switching Device Comprising at Least Three Similar Interrupter Units

(75) Inventors: Bernd Bruchmann, Berlin (DE); Horst Waage, Berlin (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/793,182

(22) PCT Filed: Nov. 29, 2005
(86) PCT No.: PCT/EP05/56303

§ 371 Date: Jun. 13, 2007

(30) Foreign Application Priority Data
Dec. 13, 2004 (DE) 10 2004 061 277.3

(51) Int. Cl. H01H 33/02

(52) U.S. Cl. 218/152; 200/48 P

(57) ABSTRACT

A polyphase switching device includes several interrupter units. The interrupter units are equipped with a first and a second terminal. The terminals lie on a respective main axis and the main axes of the individual interrupter units are aligned in parallel. All distances between the main axes are different. The invention thus provides a multi-functional polyphase switching device.

The invention relates to a polyphase switching device comprising at least three similar interrupter units, which each have a first and a second connection piece, which each lie on a main axis, the main axes being aligned approximately parallel to one another.

Such a polyphase switching device is known, for example, from the patent specification U.S. Pat. No. 6,630,638 B1. The polyphase switching device therein has three interrupter units, which are each surrounded by a separate encapsulating housing. In order to connect the interrupter units to an electrical energy transmission system, in each case outdoor bushings are arranged on the encapsulating housings for the purpose of leading in electrical conductors.

The encapsulating housings and therefore also the interrupter units of the known polyphase switching device which are located in the interior are pressed tightly against one another. In order to ensure that air-insulated electrical conductors are spaced apart from one another as required at the free ends of the outdoor bushings, they are each drawn apart from one another in the manner of a fan. Owing to the compact arrangement of the interrupter units in relation to one another, a small positioning area for the electrical switching device is required. Retrofitting or extending the known polyphase switching device with further assemblies, for example with grounding switches or disconnectors, is barely possible owing to the tight spatial conditions, however.

The invention is based on the object of specifying a polyphase switching device which can be used flexibly and has sufficient reserves for introducing further assemblies.

The object is achieved according to the invention in the case of a polyphase switching device of the type mentioned at the outset by virtue of the fact that all of the distances between the main axes have different absolute values.

Owing to different absolute values for the distances between the main axes of the interrupter units being selected, it is possible to construct a polyphase switching device which has an asymmetrical distribution of the interrupter units. Owing to the asymmetrical distribution, different regions are provided on the switching device which are available for subsequent installation of further assemblies such as grounding switches, voltage or current transformers or the like. The different distances between the main axes make it possible to provide regions and volumes of different sizes on the switching device in order to retrofit assemblies, such as switching devices, voltage transformers or other monitoring devices, of different sizes.

The interrupter units can be designed, for example, such that two contact pieces, which are capable of moving in relation to one another, are arranged axially opposite one another and one or both contact pieces can be displaced along the axis. The connection pieces of the interrupter unit lie at each of the ends facing away from the switching point of the contact pieces. With such an embodiment, the main axis of the interrupter unit and the axis along which the relative movement of the contact pieces takes place are virtually identical.

The connection pieces are then advantageously designed to be substantially rotationally symmetrical and are arranged coaxially with respect to the axis.

Advantageously, provision may be made for the main axes to be arranged in a common plane.

Given an arrangement of the main axes in a common plane, the switching device can be implemented, for example, with a dead-tank design. Owing to the arrangements in one plane in conjunction with the selection of the distances between the main axes, regions of different sizes are available between the interrupter units of the individual phases for installation of elements of different sizes.

In this case, provision may advantageously further be made for each of the interrupter units to be surrounded by a separate encapsulating housing.

Encasing the interrupter units with separate encapsulating housings further makes it possible to set the distances between the main axes variably depending on the installation location. Each of the encapsulating housings with the respective interrupter units acts independently of the others with regard to arc quenching, dielectric strength etc.

A further advantageous configuration may provide that, for the electrical connection of the interrupter units, in each case at least one outdoor bushing is arranged with a substantially radial alignment with respect to the main axis of the respective encapsulating housing.

Electrical lines can be inserted safely into the interior of the encapsulating housing by means of outdoor bushings. The radial alignment makes it possible to safely space live parts apart from the housing. It is thus possible for the encapsulating housing to consist, for example, of an electrically conductive material and to itself carry ground potential. This results in robust weather-resistant arrangements which can also be used, for example, under more difficult climatic conditions.

A further advantageous configuration can provide that two outdoor bushings are each pivoted from a perpendicular about the main axes with an opposite sense of direction, and an outdoor bushing is arranged in the perpendicular.

Such a configuration can lead, for example, to the configuration of outdoor bushings of three phases of the switching device which are arranged in the form of a fan in relation to one another. As a result, it is easily possible to produce sufficient clearance at the free ends of the outdoor bushings which carry different electrical potentials.

Furthermore, provision may advantageously be made for all of the outdoor bushings to be pivoted by up to a maximum of 45° from a perpendicular in each case about the main axes, one outdoor bushing being pivoted out with a sense of direction which is different than the other outdoor bushings.

In conjunction with the different distances between the main axes of the interrupter units and pivoting of all of the outdoor bushings, one of the outdoor bushings being pivoted out with a different sense of direction, it is ensured that sufficient clearances are maintained between the outdoor bushings. In addition, given an arrangement of the interrupter units in one plane, it is possible to achieve a situation in which the height of the connection points at the free ends of the outdoor bushings is in each case the same for all phases. This results in advantages in the event of a restricted installation of the electrical switching device, for example beneath a high-voltage line. In comparison with outdoor bushings which are fanned open symmetrically and in which the connection point of the centrally arranged bushing is higher than the connection points of outdoor bushings which are pivoted laterally away, it is also possible for a switching device according to the invention to be used on areas which have a low height and have been built on.

Furthermore, provision may advantageously be made for the switching device to be a single-phase-encapsulated switching device having a dead-tank design, and the switching device to be a high-voltage circuit breaker.

Switching devices having a dead-tank design are known, for example, from the prior art. A configuration of a high-voltage circuit breaker having a dead-tank design according to the invention is compatible with already existing arrangements, i.e., when worn high-voltage circuit breakers are being replaced, it is easily possible for a high-voltage circuit breaker according to the invention to be used.

Provision may advantageously furthermore be made for at least one outdoor bushing to be flange-connected directly to a flange arranged on the encapsulating housing.

Owing to an outdoor bushing being flange-connected directly to the encapsulating housing, a mechanically robust unit is produced. Oscillations of the outdoor bushings owing to switching operations or wind loads can be limited to a permissible degree.

A further advantageous configuration may provide that at least one outdoor bushing is flange-connected indirectly to an encapsulating housing with the interposition of a further housing assembly.

Interposing a further housing assembly makes it possible to attach further component parts in compact form to the polyphase switching device. As a result, for example, the interior of the housing assembly can be utilized.

In this case, provision may advantageously be made for a disconnector and/or a grounding switch to be arranged in the further housing assembly.

Owing to the arrangement of disconnectors or grounding switches within a further housing assembly, said devices are protected from external environmental influences. At the same time, the environment is protected from hazards which arise from the switching devices arranged in the interior of the housing assembly.

In addition, by equipping the polyphase switching device with a further housing assembly, the number of possible circuit variants is increased. The polyphase electrical switching device can therefore be used in a variety of ways. For example, provision may be made for individual overhead line sections to be isolated via the grounding switch and the disconnector and for them then to be grounded.

One exemplary embodiment of the invention will be shown schematically in a drawing and described in more detail below, in which drawing:

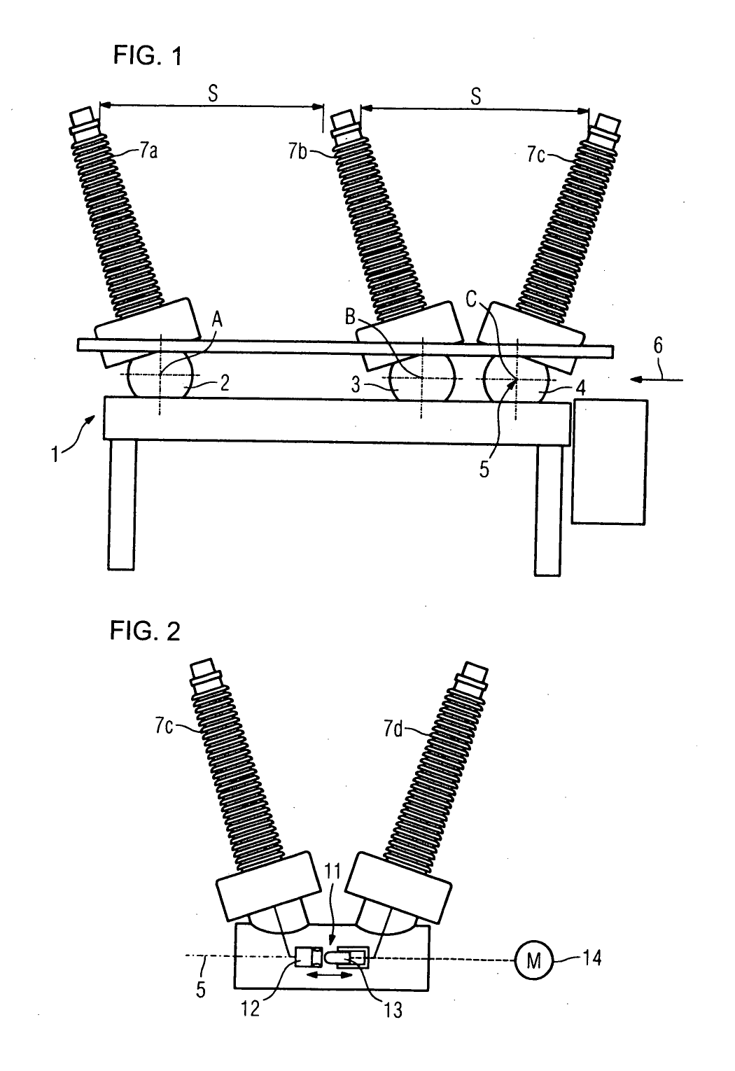

FIG. 1 shows a front view of a polyphase switching device,

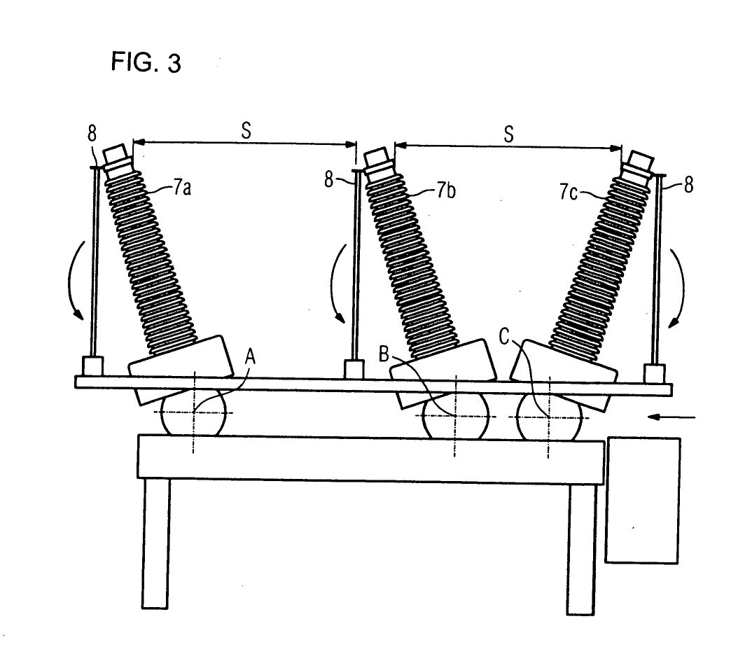

FIG. 2 shows a side view of the polyphase switching device illustrated in FIG. 1,

FIG. 3 shows a front view of the switching device known from FIG. 1 with an outdoor grounding switch, and

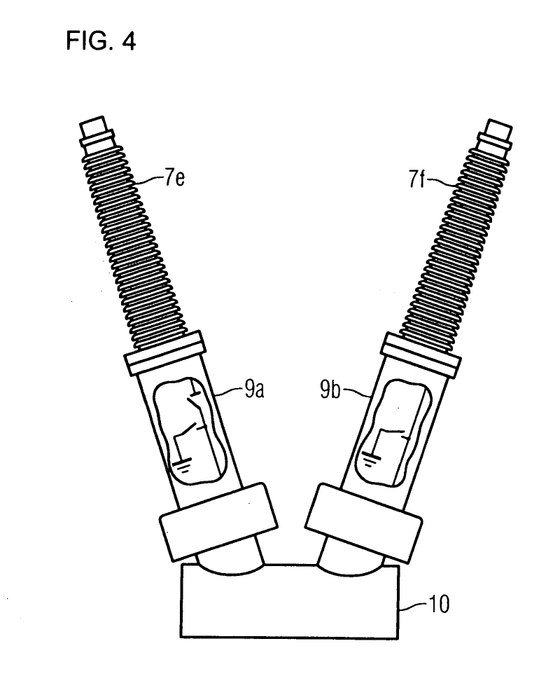

FIG. 4 shows a side view of an electrical switching device with outdoor bushings and interposed further housing assemblies.

FIG. 1 shows a. polyphase switching device 1. The polyphase switching device has three phases A, B, C. Each of the three phases A, B, C has a separate encapsulating housing 2, 3, 4 associated with it. The encapsulating housings 2, 3, 4 are each manufactured from an electrically conductive material and surround an interrupter unit of a high-voltage circuit breaker. The encapsulating housings 2, 3, 4 have a substantially tubular structure. The respective interrupter units of the phases A, B, C are arranged in the interior of the encapsulating housings 2, 3, 4 along the tube axes of the encapsulating housings 2, 3, 4. In FIG. 1, the main axes protrude at right angles from the plane of the drawing. A main axis 5 of the phase C can be seen in a side view in FIG. 2. The viewing direction of the illustration in FIG. 2 is indicated by an arrow 6 in FIG. 1. By way of example, an interrupter unit 11 is illustrated in FIG. 2. The interrupter unit 11 has a first contact piece 12 and a second contact piece 13. The contact pieces 12, 13 are coaxial with respect to the main axis 5. The first contact piece 12 is in the form of a tulip contact, and the second contact piece 13 is in the form of a bolt. The second contact piece 13 can be displaced along the main axis 5 via a drive device 14. The connection pieces are designed to be substantially rotationally symmetrical and are arranged at those ends of the contact pieces 12, 13 which face away from the switching point.

In order to supply the electrical lines to the interrupter units located in the interior of the encapsulating housings 2, 3, 4, in each case one first and one second outdoor bushing 7a, b, c, d are arranged on the casing side on the encapsulating housings 2, 3, 4. The main axes of the phases A, B, C are each arranged in a common plane and are aligned parallel to one another. All of the distances between the main axes of the phases A, B, C are different than one another. For example, the distance between the main axes of phases A and C is greater than the distance between the main axes of phases A and B and greater than the distance between the main axes of phases B and C, the distance between the main axes of phases A and B in turn being greater than the distance between the main axes of phases B and C.

In addition to the arrangement illustrated in FIG. 1, however, provision may also be made for the main axes to be arranged parallel to one another, but to lie in different planes, with the result that a so-called triangular arrangement is produced. In this case, too, the distances between all of the main axes differ from one another. Furthermore, provision may also be made for one or more of the outdoor bushings of phases A, B, C to lie in a perpendicular.

In order to ensure a sufficient clearance S at the free ends of the outdoor bushings, the axes of the outdoor bushings are pivoted out of a perpendicular. In this case, the axes are all deflected by the same amount. The outdoor bushings of phases A and B are in each case deflected with the same sense of direction. The outdoor bushings of phase C are deflected by the same amount, but with a different sense of direction. This results in an arrangement in which the connection points of the outdoor bushings are at one and the same height, approximately equal distances S being provided between the connection points of the outer outdoor bushings and the central outdoor bushing.

Given the asymmetrical distribution of the main axes illustrated in FIG. 1, an accommodating area for arranging further assemblies such as grounding switches or the like is produced between phases A and B. Such a space is not provided between phases B and C. Owing to the asymmetrical arrangement, the whole polyphase switching device can be rotated about a vertical axis, with the result that the installation space provided for retrofitting further assemblies can be rotated into the desired position.

FIG. 3 illustrates, by way of example, the way in which the polyphase switching device illustrated in FIG. 1 is equipped with an outdoor grounding switch 8. The outdoor grounding switch 8 has a pivotable rod at each phase which is mounted in rotatable fashion in the vicinity of the base point of the outdoor bushings 7a, 7b, 7c. They are also connected there to ground potential. For grounding purposes, the grounding rods can be pivoted upwards into the position illustrated in figure 3 and enter a mating contact there at the free end of the respective outdoor bushings 7a, 7b, 7c. The grounding rods are arranged on the outside at the two outer phases A, C. The grounding rod is arranged in the space obtained by the asymmetrical distribution of the interrupter unit at the central phase B. Owing to the pivoting-out, which is identical but is carried out with a different sense of direction, and the identical height achieved thereby of the connection points of the outdoor bushings, identical grounding rods can also be used for all three phases at the outdoor grounding switch 8.

FIG. 4 shows a further configuration of one phase of a polyphase switching device, the outdoor bushings 7e, 7f being flange-connected to the encapsulating housing 10 with in each case one further housing assembly 9a, 9b interposed. Disconnectors or grounding switches, for example, may be arranged in the interior of the further housing assemblies 9a, 9b. The conductor bar, which is introduced into the interior of the encapsulating housing 10 via the outdoor bushings 7e, 7f, for example, can be disconnected by means of the disconnector. Ground potential can be applied to the corresponding conductor bar by means of the grounding switch. In the interior of the encapsulating housing, the disconnectors or grounding switches are protected from external environmental influences. Furthermore, the outdoor bushings, which are at a high voltage potential, are flange-connected indirectly to the encapsulating housing 10, further removed from said encapsulating housing. As a result, a risk to operational personnel is avoided since parts carrying high voltages are spaced further apart from the operating personnel.

1-11. (canceled)

12. A polyphase switching device, comprising:
at least three interrupter units of a common type, each of said interrupter units having a first connection piece and a second connection piece, and each lying on a main axis;
the main axes being aligned approximately parallel to one another, and spaced apart from one another by respective spacing distances, and wherein said spacing distances between said main axes have different absolute values.

13. The polyphase switching device according to claim 12, wherein the main axes are arranged in a common plane. cm. 14. The polyphase switching device according to claim 12, wherein each of said interrupter units is surrounded by a separate encapsulating housing.

15. The polyphase switching device according to claim 14, wherein, for the electrical connection of the interrupter units, in each case at least one outdoor bushing is disposed with a substantially radial alignment with respect to the main axis of the respective said encapsulating housing.

16. The polyphase switching device according to claim 15, wherein two of said outdoor bushings are pivoted from a perpendicular about the main axes in opposite directions, and one outdoor bushing is disposed in the perpendicular.

17. The polyphase switching device according to claim 15, wherein each of said outdoor bushings is pivoted from a perpendicular by up to a maximum of 45° about the main axes, and one of said outdoor bushings is pivoted in an opposite direction from the remaining said outdoor bushings.

18. The polyphase switching device according to claim 12 configured as a single-phase-encapsulated switching device having a dead-tank design, and wherein the switching device is a high-voltage circuit breaker.

19. The polyphase switching device according to claim 15, wherein at least one of said outdoor bushings is flange-connected directly to a flange disposed on said encapsulating housing.

20. The polyphase switching device according to claim 15, wherein at least one of said outdoor bushings is flange-connected indirectly to an encapsulating housing, and wherein a further housing assembly is interposed therebetween.

21. The polyphase switching device according to claim 20, which comprises a disconnector disposed in said further housing assembly.

22. The polyphase switching device according to claim 20, which comprises a grounding switch disposed said further housing assembly.
